(19) United States
(12) Patent Application Publication
(10) Pub. No.: US 2025/0103772 A1
(43) Pub. Date: Mar. 27, 2025

(54) METHOD AND DEVICE FOR MULTI-MATERIAL TOPOLOGY OPTIMIZATION OF ELECTRIC MOTORS FOR DETERMINING OPTIMAL ARRANGEMENT OF PERMANENT MAGNETS

(71) Applicant: Korea Advanced Institute Of Science And Technology, Daejeon (KR)

(72) Inventors: In Gwun JANG, Daejeon (KR); Changwoo Lee, Daejeon (KR)

(21) Appl. No.: 18/626,563

(22) Filed: Apr. 4, 2024

(30) Foreign Application Priority Data
Aug. 3, 2023 (KR) 10-2023-0101694
Dec. 21, 2023 (KR) 10-2023-0188389

(51) Int. Cl. G06F 30/23

(52) U.S. Cl. CPC G06F 30/23

(57) ABSTRACT

The present disclosure proposes a method and device for multi-material topology optimization for optimal arrangement of a permanent magnet in an electric motor. The present disclosure relates to multi-material topology optimization for optimal arrangement of a permanent magnet in an electric motor including a stator, a rotor, and at least one permanent magnet provided to the rotor, and may be configured to express multi-materials of each of a plurality of finite elements divided from at least a partial area of the rotor, as a plurality of design variables defined to express multi-material states; and to derive topology optimization for a structure of the permanent magnet in the rotor using the design variables, for at least one of usage minimization of the permanent magnet and torque density maximization for the electric motor.

### CROSS-REFERENCE TO RELATED APPLICATION(S)

This application claims the priority to and benefit of Korean Patent Application Nos. 10-2023-0101694, filed on Aug. 3, 2023, and 10-2023-0188389, filed on Dec. 21, 2023 in the Korean Intellectual Property Office, which are hereby incorporated by reference in their entireties.

### BACKGROUND

### 1. Field of the Invention

The present disclosure relates to a method and device for multi-material topology optimization for optimal arrangement of a permanent magnet (PM) in an electric motor.

### 2. Description of the Related Art

An electric motor with a permanent magnet is widely used as an eco-friendly motor and the demand for the electric motor is increasing. Expensive rare materials, for example, neodymium, dysprosium, and terbium, are used to produce the permanent magnet. However, due to a recent rise in raw material price, the price of rare earth materials is also rapidly increasing.

Types of electric motors are classified according to a permanent magnet arraignment method. For example, the types include a surface-mounted type, an insertion type, a synchronous reluctance type, and a spoke type. As such, although various types are present, there is a common goal of maximizing a torque density, that is, torque per unit volume while minimizing permanent magnet usage.

In general, a designer of an electric motor needs to directly determine quantity, dimension, and arrangement for a permanent magnet. Accordingly, the permanent magnet usage and the torque density for the electric motor may greatly vary depending on the designer's capability.

### SUMMARY

The present disclosure provides a multi-material topology optimization method and device that may determine quantity, dimension, and arrangement for a permanent magnet to maximize a torque density while minimizing permanent magnet usage for an electric motor.

The present disclosure provides a multi-material topology optimization method and device that may determine quantity, dimension, and arrangement of a permanent magnet based on a softwarely designed algorithm without prior information.

The present disclosure proposes a device and method for multi-material topology optimization for optimal arrangement of a permanent magnet in an electric motor.

The present disclosure provides a method of a computer device that performs multi-material topology optimization for optimal arrangement of a permanent magnet in an electric motor including a stator, a rotor, and at least one permanent magnet provided to the rotor, and the method may include expressing multi-materials of each of a plurality of finite elements divided from at least a partial area of the rotor, as a plurality of design variables defined to express multi-material states; and deriving topology optimization for a structure of the permanent magnet in the rotor using the design variables, for at least one of usage minimization of the permanent magnet and torque density maximization for the electric motor.

The present disclosure provides a computer device that performs multi-material topology optimization for optimal arrangement of a permanent magnet in an electric motor including a stator, a rotor, and at least one permanent magnet provided to the rotor, and the computer device may include a memory; and a processor configured to connect to the memory, and to execute at least one instruction stored in the memory, and the processor may be configured to express multi-materials of each of a plurality of finite elements divided from at least a partial area of the rotor, as a plurality of design variables defined to express multi-material states, and to derive topology optimization for a structure of the permanent magnet in the rotor using the design variables, for at least one of usage minimization of the permanent magnet and torque density maximization for the electric motor.

The present disclosure provides a non-transitory computer-readable recording medium storing instructions that, when executed by a processor, cause the processor to perform a method of performing multi-material topology optimization for optimal arrangement of a permanent magnet in an electric motor including a stator, a rotor, and at least one permanent magnet provided to the rotor, and the method may include expressing multi-materials of each of a plurality of finite elements divided from at least a partial area of the rotor, as a plurality of design variables defined to express multi-material states; and deriving topology optimization for a structure of the permanent magnet in the rotor using the design variables, for at least one of usage minimization of the permanent magnet and torque density maximization for the electric motor.

Since a structure of a permanent magnet is predefined relying on the intuition of a designer in the art, it is difficult to design an electric motor with nonlinearity (magnetic flux saturation and leakage flux) and complex structure. However, the present disclosure may perform a multi-material topology optimization of determining a permanent magnet structure, that is, quantity, dimension, and arrangement for a permanent magnet, for maximizing a torque density while minimizing permanent magnet usage for an electric motor based on a softwarely designed algorithm without prior information. According to the present disclosure, it is easy to design a complex electric motor with multiple constraints without a need to rely on the intuition of a designer. Accordingly, the present disclosure may significantly reduce an amount of time and cost used for design, manufacturing, and experiments by making it unnecessary to manufacture a plurality of individual products and repeat experiments for each individual product.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1A illustrates a structure of an exemplary permanent magnet insertion-type electric motor;

FIG. 1B is a graph showing a magnetic flux characteristic of a rotor in an electric motor of FIG. 1A;

FIG. 1C illustrates rotors according to various types of an electric motor.

FIG. 2 is a diagram illustrating a computer device that performs multi-material topology optimization for optimal arrangement of a permanent magnet in an electric motor according to the present disclosure;

FIG. 3 is a flowchart illustrating a method of a computer device for topology optimization of an electric motor according to the present disclosure;

FIG. 4 is a flowchart illustrating in detail an operation of expressing finite elements of a rotor as a plurality of design variables for multi-materials in FIG. 3;

FIG. 5 illustrates an example of an operation of expressing finite elements of a rotor as a plurality of design variables for multi-materials in FIG. 3;

FIG. 6 is a flowchart illustrating in detail an operation of deriving topology optimization by performing filtering and clustering on finite elements in FIG. 3;

FIG. 7 illustrates an example of an operation of verifying adjacent finite elements in FIG. 6;

FIGS. 8, 9, and 10 illustrate examples of an operation of performing filtering and clustering on adjacent finite elements in FIG. 6; and

FIG. 11 illustrates an example of a rotor manufactured as topology optimization for a structure of a permanent magnet according to the present disclosure.

### DETAILED DESCRIPTION

Hereinafter, example embodiments will be described with reference to the accompanying drawings.

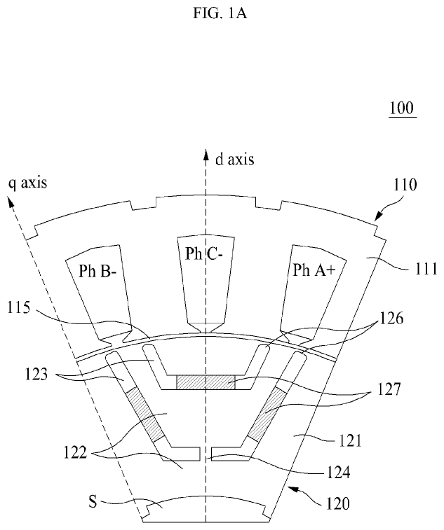

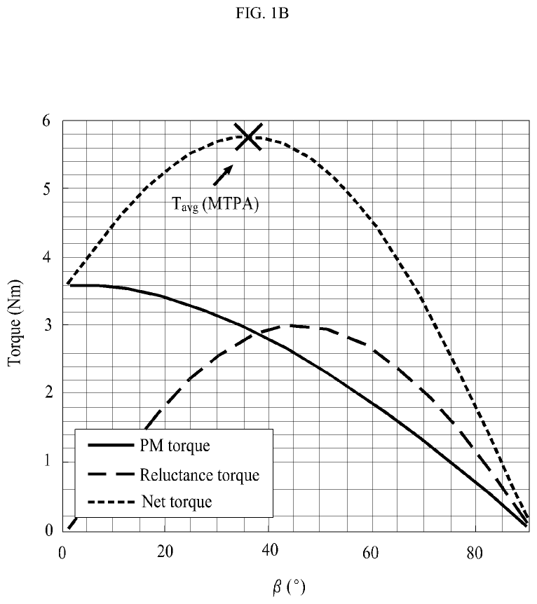

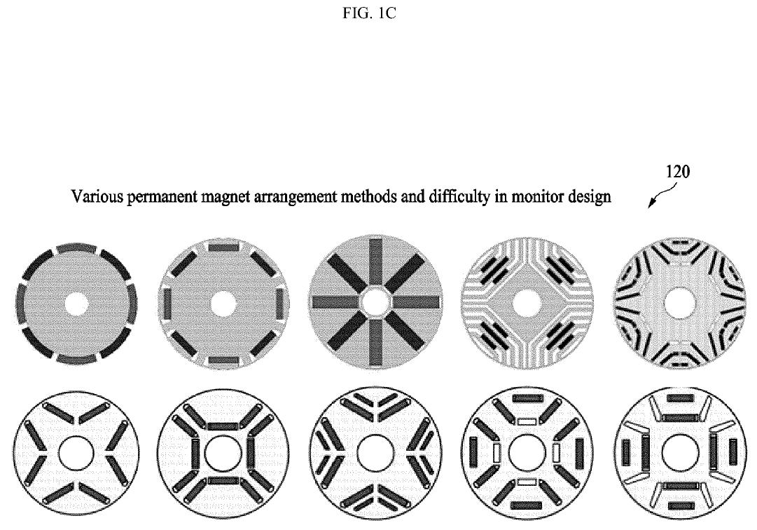

FIG. 1A illustrates a structure of an exemplary electric motor 100. Here, FIG. 1A illustrates a case in which the electric motor 100 is implemented as a permanent magnet insertion type. FIG. 1B is a graph showing a magnetic flux characteristic of a rotor 120 in the electric motor 100 of FIG. 1A. FIG. 1C illustrates the rotors 120 according to various types of the electric motor 100.

Referring to FIG. 1A, the electric motor 100 includes a stator 110 and the rotor 120, and operates according to torque generated by interaction between magnetic flux (e.g., N pole) of the rotor 120 and magnetic flux (e.g., S pole) of the stator 110. Here, the rotor 120 is implemented to rotate inside the stator 110 based on a shaft(S). Here, airgap 115 is provided between the stator 110 and the rotor 120.

The stator 110 includes an iron core 111 and a winding (not shown). In response to current being applied to the winding, the magnetic flux is generated and induced in the iron core 111.

The rotor 120 includes an iron core 121 and at least one permanent magnet 127. The iron core 121 includes a plurality of webs 122, at least one bridge 124, and a plurality of ribs 126. The webs 122 prevents local magnetic saturation by distributing the concentrating magnetic flux. To this end, at least one barrier 123 is provided between the webs 122 in the rotor 120, and the webs 122 are separated from each other by way of the barrier 123. The bridge 124 and the ribs 126 serve to structurally support the rotor 120 to withstand load received during rotation, that is, the webs 122 to not fly away. The bridge 124 and the ribs 126 connect the webs 122 while crossing the barrier 123. The bridge 124 crosses a middle area of the barrier 123 such that the barrier 123 is separated with the bridge 124 in between. The ribs 126 cross both end areas of the barrier 123 such that the barrier 123 is separated from the airgap 115 by way of the ribs 126. The permanent magnet 127 may strengthen the magnetic flux that flows along the webs 122. The permanent magnet 127 is inserted between the webs 122, that is, inside the barrier 123.

In the rotor 120, the permeability of iron is about 1,000 times higher than that of air, so the magnetic flux tends to flow along the iron core 121. As shown in FIG. 1B, net torque of the rotor 120 may be expressed as a sum of reluctance torque and torque by the permanent magnet 127. As shown in FIG. 1A, the web 122 is in a salient structure and when the web 122 rotates, the magnetic flux permeability viewed from the stator 110 varies. That is, when the rotor 120 rotates, the total magnetic flux amount transmitted through the rotor 120 varies and the torque is generated even without the permanent magnet 127, which is generally called reluctance torque. Meanwhile, the magnetic flux generated due to the permanent magnet 127 flows along the webs 122, which may result in increasing the magnetic flux density of the webs 122 and improving the torque, which is generally called permanent magnet torque.

Therefore, the permanent magnet 127 needs to be provided to make it possible to maximize the torque by the permanent magnet 127 and, at the same time, the iron core 111 needs to be designed to make it possible to maximize the reluctance torque. Meanwhile, although a case in which the electric motor 100 is implemented as the permanent magnet insertion type is described, the present disclosure is not limited thereto. That is, as shown in FIG. 1C, the electric motor 100 may be implemented as various types, such as a surface-mounted type, a permanent magnet insertion type, a synchronous reluctance type, and a spoke type, according to an arrangement method of the permanent magnet 127 in the rotor 120. Through this, various combinations may be present for the structure of the electric motor 100. Therefore, the present disclosure proposes technology for finding an optimal combination for the structure of the electric motor 100 to maximize the net torque of the rotor 120. Accordingly, hereinafter, the present disclosure describes the computer device 200 that performs multi-material topology optimization for optimal arrangement of the permanent magnet 127 in the electric motor 100 and a method thereof.

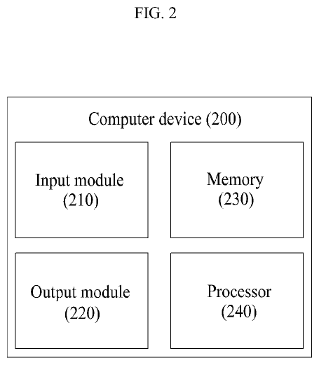

FIG. 2 is a diagram illustrating the computer device 200 that performs multi-material topology optimization for optimal arrangement of the permanent magnet 127 in the electric motor 100 according to the present disclosure.

Referring to FIG. 2, the computer device 200 may include at least one of an input module 210, an output module 220, a memory 230, and a processor 240. In some example embodiments, at least one of components of the computer device 200 may be omitted and at least one another component may be added. In some example embodiments, at least two components among the components of the computer device 200 may be implemented as a single integrated circuit.

The input module 210 inputs a signal to be used for at least one component of the computer device 200. The input module 210 includes at least one of an input device configured for a user to directly input a signal to the computer device 200, a sensor device configured to generate a signal by detecting a surrounding change, and a reception device configured to receive a signal from an external device. For example, the input device includes at least one of a microphone, a mouse, and a keyboard. In some example embodiments, the input device includes at least one of a touch circuitry set to detect a touch and a sensor circuitry set to measure intensity of force generated by the touch.

The output module 220 outputs information to the outside of the computer device 200. The output module 220 includes at least one of a display device configured to visually output information, an audio output device configured to output information as an audio signal, and at least one a transmission device configured to wirelessly transmit information. For example, the display device includes at least one of a display, a hologram device, and a projector. For example, the display device is implemented as a touchscreen by being assembled to at least one of the touch circuitry and the sensor circuitry of the input module 210. For example, the audio output device includes at least one of a speaker and a receiver.

According to an example embodiment, the reception device and the transmission device are implemented as a communication module. The communication module performs communication with an external device in the computer device 200. The communication module establishes a communication channel between the computer device 200 and the external device and performs communication with the external device through the communication channel. Here, the external device includes at least one of a vehicle, a satellite, a base station, a server, and another computer system. The communication module includes at least one of a wired communication module and a wireless communication module. The wired communication module is connected to the external device in a wired manner and communicates with the external device in a wired manner. The wireless communication module includes at least one of a near field communication module and a far field communication module. The near field communication module communicates with the external device using a near field communication scheme. For example, the near field communication scheme includes at least one of Bluetooth, wireless fidelity (WiFi) direct, and infrared data association (IrDA). The far field communication module communicates with the external device using a far field communication scheme. Here, the far field communication module communicates with the external device over a network. For example, the network includes at least one of a cellular network, the Internet, and a computer network, such as a local area network (LAN) and a wide area network (WAN).

The memory 230 stores a variety of data used by at least one component of the computer device 200. For example, the memory 230 includes at least one of a volatile memory and a non-volatile memory. Data includes at least one program and input data or output data related thereto. The program may be stored in the memory 230 as software that includes at least one instruction and includes at least one of an operating system (OS), middleware, and an application.

The processor 240 controls at least one component of the computer device 200 by executing the program of the memory 230. Through this, the processor 240 performs data processing or operation. Here, the processor 240 executes an instruction stored in the memory 230.

According to various example embodiments, the processor 240 expresses finite elements of the rotor 120 as a plurality of design variables for multi-materials. That is, the processor 240 expresses multi-materials of each of the finite elements as design variables designed to express multi-material states. Here, the rotor 120 may include the multi-material, the permanent magnet 127, iron, and air. Here, when the number of material states is N, the number of design variables is at least (N−1). In some example embodiments, the material states include a relative density of the permanent magnet 127, a direction of the permanent magnet 127, a relative density of iron in the rotor 120, and a relative density of air, and to express such four material states, three design variables, that is, ρₑ^{(PM)}, θₑ^{(PM)}, and ρₑ^{(iron)} are defined.

According to various example embodiments, the processor 240 derives topology optimization for the structure of the permanent magnet 127 in the rotor 120 using design variables to maximize the torque density while minimizing usage of the permanent magnet 127 for the electric motor 100. Here, the structure of the permanent magnet 127 includes quantity, dimension, and arrangement for the permanent magnet 127 in the rotor 120. In detail, the processor 240 derives the topology optimization by performing filtering and clustering on finite elements. The processor 240 performs filtering and clustering on adjacent finite elements within radii differently determined according to the material states. Here, the processor 240 determines a weight according to a distance from each of the adjacent finite elements and performs filtering and clustering on the adjacent finite elements based on the weight. The weight indicates a degree of influence by the adjacent finite elements.

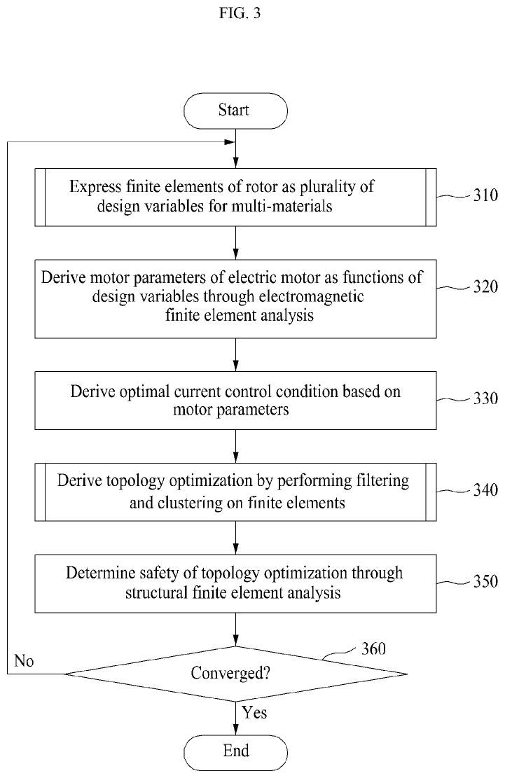

FIG. 3 is a flowchart illustrating a method of the computer device 200 for topology optimization of the electric motor 100 according to the present disclosure.

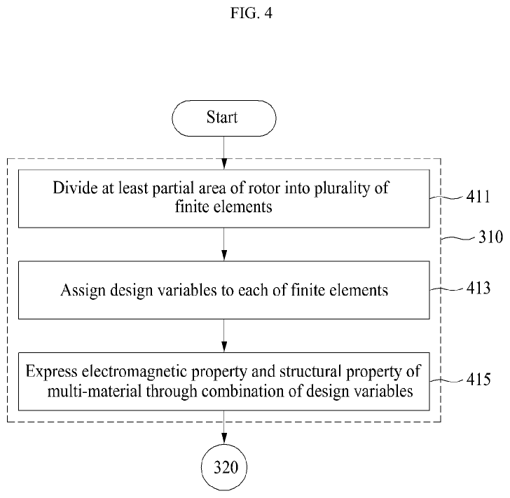

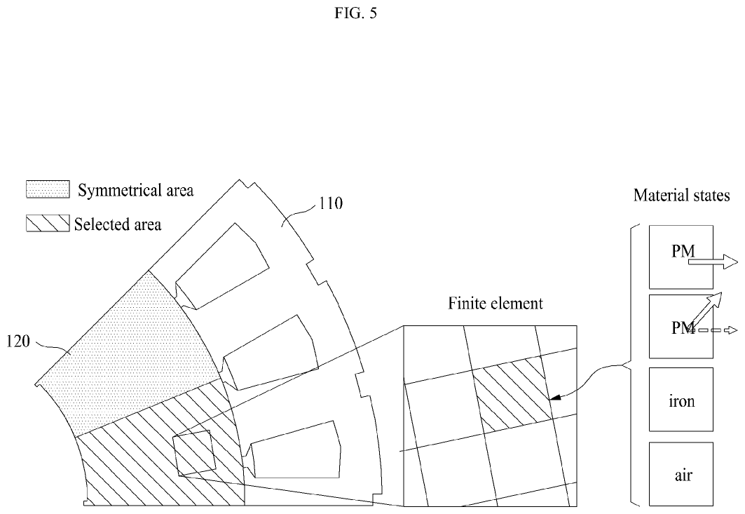

Referring to FIG. 3, in operation 310, the computer device 200 expresses finite elements of the rotor 120 as a plurality of design variables for multi-materials. That is, the processor 240 expresses multi-material of each of the finite elements as the design variables defined to express multi-material states. Here, the rotor 120 may include the multi-material, the permanent magnet 127, iron, and air. Further description related thereto will be made with reference to FIGS. 4 and 5.

FIG. 4 is a flowchart illustrating in detail an operation (operation 310) of expressing finite elements of a rotor as a plurality of design variables for multi-materials in FIG. 3. FIG. 5 illustrates an example of an operation (operation 310) of expressing finite elements of a rotor as plurality of design variables for multi-materials in FIG. 3.

Referring to FIG. 4, in operation 411, the computer device 200 divides at least a partial area of the rotor 120 into a plurality of finite elements. In detail, the processor 240 selects at least a partial area of the rotor 120 and divides the selected area into the finite elements using a fixed grid. For example, as shown in FIG. 5, the processor 240 divides the selected area of the rotor 120 into the finite elements and, through this, the finite elements are arranged in a grid form.

In operation 413, the computer device 200 assigns design variables to each of the finite elements. Here, the design variables to express the material states are defined, and the processor 24 assigns the design variables to each of the finite elements. Here, when the number of material states is N, the number of design variables is at least (N−1). In some example embodiments, the material states include a relative density of the permanent magnet 127, a direction of the permanent magnet 127, a relative density of iron in the rotor 120, and a relative density of air. To express these four material states, three design variables, i.e., ρₑ^{(PM)}, θₑ^{(PM)}, and ρₑ^{(iron)} are defined. For example, as shown in FIG. 5, the processor 240 assigns three design variables for expressing four material states to each of the finite elements.

In operation 415, the device 200 expresses electromagnetic property and structural property of multi-material through combination of design variables. In subsequent operations, multi-physics finite element analysis, that is, each of electromagnetic finite element analysis and structural finite element analysis is performed. Therefore, the processor 240 expresses the electromagnetic property and the structural property of each of the finite elements as combination of the design variables.

The purpose of the electromagnetic finite element analysis is to calculate the torque of the electric motor 100, that is, the average torque and torque ripple in the given topology. Solving Maxwell's equation for an arbitrary finite element, that is, an e-th finite element, the torque of the electric motor 100 may be calculated. Here, Maxwell's equation for the e-th finite element may be expressed as three design variables, that is, ρₑ^{(PM)}, θₑ^{(PM)}, and ρₑ^{(iron)} as shown in [Equation 1] to [Equation 3] below.

In detail, Maxwell's equation for the e-th finite element is expressed as [Equation 1].

$${H}_{e} = {v}_{e}^{( SIMP )} {B}_{e}^{( iron )} + {B}_{e}^{( PM )} \qquad [ Equation 1 ]$$

Here, the subscript e denotes the e-th finite element and bold fonts represent vectors. H represents electric field intensity (unit: A/m), B represents a magnetic flux density (unit: T), v_{e(SIMP)} denotes a reluctivity of the e-th finite element expressed as [Equation 2] below, Bₑ^{(iron)} represents the magnetic flux density due to iron, and Bₑ^{(PM)} represents the magnetic flux density due to the permanent magnet 127 expressed as [Equation 3] below.

The reluctivity of the e-th finite element is expressed as a function of two design variables, that is, ρₑ^{(PM)} and ρₑ^{(iron)}, as shown in [Equation 2] below. That is, the reluctivity may represent iron or air according to combination of two design variables, that is, ρₑ^{(PM)} and ρₑ^{(iron)}.

$${v}_{e}^{( SIMP )} = {v}^{( air )} + ( {v}_{e}^{( iron )} - {v}^{( air )} ) {( {ρ}_{e}^{( iron )} )}^{p} - ( 1 - {( {ρ}_{e}^{( PM )} )}^{p} ) \qquad [ Equation 2 ]$$

$$\{ \begin{matrix}\begin{matrix}{v}_{e}^{( SIMP )} = {v}^{( air )} + ( {v}_{e}^{( iron )} - {v}^{( air )} ) \\ {( {\underbrace{{ρ}_{e}^{( iron )}}}_{1} )}^{p} ( {( {\underbrace{1 - ( {\underbrace{{ρ}_{e}^{( PM )}}}_{0} )}}_{1} )}^{p} ) = {v}_{e}^{( iron )}\end{matrix} ( if {ρ}_{e}^{( iron )} = 1 and {ρ}_{e}^{( PM )} = 0 ) \\ \begin{matrix}{v}_{e}^{( SIMP )} = {v}^{( air )} + ( {v}_{e}^{( iron )} - {v}^{( air )} ) \\ {( {\underbrace{{ρ}_{e}^{( iron )}}}_{1} )}^{p} = {v}^{( air )}\end{matrix} ( if {ρ}_{e}^{( iron )} = 1 and {ρ}_{e}^{( PM )} = 1 ) \\ \begin{matrix}{v}_{e}^{( SIMP )} = {v}^{( air )} + ( {v}_{e}^{( iron )} - {v}^{( air )} ) \\ ( {{\underbrace{1 - ( {\underbrace{{ρ}_{e}^{( PM )}}}_{0} )}}_{1}}^{p} ) = {v}^{( air )}\end{matrix} ( if {ρ}_{e}^{( iron )} = 0 and {ρ}_{e}^{( PM )} = 0 ) \\ \begin{matrix}{v}_{e}^{( SIMP )} = {v}^{( air )} + \\ ( {v}_{e}^{( iron )} - {v}^{( air )} ) = {v}^{( air )}\end{matrix} ( if {ρ}_{e}^{( iron )} = 0 and {ρ}_{e}^{( PM )} = 1 )\end{matrix}$$

Here, p denotes a penalization parameter (generally, uses a value of 3 or more), v^{(iron)} denotes a reluctivity of iron, v^{(air)} denotes a reluctivity of air, ρₑ^{(PM)} denotes a relative density of the permanent magnet 127 of the e-th finite element (0≤ρₑ^{(PM)}≤1), and ρₑ^{(iron)} denotes a relative density of iron of the e-th finite element (0≤ρₑ^{(iron)}≤1).

The magnetic flux density due to the permanent magnet 127 of the e-th finite element is expressed as a function of three design variables, that is, ρₑ^{(PM)}, θₑ^{(PM)}, and ρₑ^{(iron)} as shown in [Equation 3] below. Here, the magnetic flux density may represent the permanent magnet 127 or iron according to combination of two design variables, that is, ρₑ^{(PM)} and ρₑ^{(iron)}. Meanwhile, the direction of the permanent magnet 127 may be determined according to a single design variable, that is, θₑ^{(PM)}.

$${B}_{e}^{( PM )} = {{B}_{residual}^{( PM )} ( {ρ}_{e}^{( PM )} )}^{p} {( 1 - {ρ}_{e}^{( iron )} )}^{p} [ \begin{matrix}cos ( {θ}_{e} ) \\ sin ( {θ}_{e} )\end{matrix} ] \qquad [ Equation 3 ]$$

$$\{ \begin{matrix}\begin{matrix}\begin{matrix}{B}_{e}^{( PM )} = {{B}_{residual}^{( PM )} ( {\underbrace{{ρ}_{e}^{( PM )}}}_{1} )}^{p} {( {\underbrace{1 - {\underbrace{{ρ}_{e}^{( iron )}}}_{0}}}_{1} )}^{p} [ \begin{matrix}cos ( {θ}_{e} ) \\ sin ( {θ}_{e} )\end{matrix} ] = {B}_{residual}^{( PM )} [ \begin{matrix}cos ( {θ}_{e} ) \\ sin ( {θ}_{e} )\end{matrix} ] \\ ( if {ρ}_{e}^{( iron )} = 0 and {ρ}_{e}^{( PM )} = 1 )\end{matrix} \\ {B}_{e}^{( PM )} = {{B}_{residual}^{( PM )} ( {\underbrace{{ρ}_{e}^{( PM )}}}_{1} )}^{p} [ \begin{matrix}cos ( {θ}_{e} ) \\ sin ( {θ}_{e} )\end{matrix} ] = [ \begin{matrix}0 \\ 0\end{matrix} ] \\ ( if {ρ}_{e}^{( iron )} = 1 and {ρ}_{e}^{( PM )} = 1 ) \\ \begin{matrix}{B}_{e}^{( PM )} = {B}_{residual}^{( PM )} {( {\underbrace{1 - {\underbrace{{ρ}_{e}^{( iron )}}}_{0}}}_{1} )}^{p} [ \begin{matrix}cos ( {θ}_{e} ) \\ sin ( {θ}_{e} )\end{matrix} ] = [ \begin{matrix}0 \\ 0\end{matrix} ] \\ ( if {ρ}_{e}^{( iron )} = 0 and {ρ}_{e}^{( PM )} = 0 )\end{matrix}\end{matrix} \\ \begin{matrix}{B}_{e}^{( PM )} = {B}_{residual}^{( PM )} [ \begin{matrix}cos ( {θ}_{e} ) \\ sin ( {θ}_{e} )\end{matrix} ] = [ \begin{matrix}0 \\ 0\end{matrix} ] \\ ( if {ρ}_{e}^{( iron )} = 1 and {ρ}_{e}^{( PM )} = 0 )\end{matrix}\end{matrix}$$

Here, B_{residual}^{(PM)} denotes a residual magnetic flux density of the permanent magnet 127, and 0ₑ^{(PM)} denotes a direction of the permanent magnet 127 of the e-th finite element (θ≤θₑ^{(PM)}≤2π).

Finally, the electromagnetic property of multi-materials is expressed through combination of design variables as shown in [Table 1] below.

TABLE 1

| | | | Electromagnetic property | | |
|---|---|---|---|---|---|
| | | | | | Direction |
| | | | | | of |
| Design variables | | | | | permanent |
| ρₑ^{(iron)} | ρₑ^{(PM)} | θₑ^{(PM)} | v^{(SIMP)} | Bₑ^{(PM)} | magnet |
| 0 | 0 | 0 ≤ θₑ^{(PM)} ≤ 2π | v^{(air)} | [0, 0] ^{T} | 0~2π |
| 1 | 1 | 0 ≤ θₑ^{(PM)} ≤ 2π | v^{(air)} | [0, 0] ^{T} | 0~2π |
| 0 | 0 | 0 ≤ θₑ^{(PM)} ≤ 2π | vₑ^{(iron)} | [0, 0] ^{T} | 0~2π |
| 0 | 1 | 0 | v^{(PM)} = v^{(air)} | Bₑ^{(PM)} | 0 |
| 0 | 1 | 1 | v^{(PM)} = v^{(air)} | Bₑ^{(PM)} | 2π |

The purpose of the structural finite element analysis is to calculate structural compliance, that is, stress and strain in the given topology. By solving a structural equation for an arbitrary finite element, that is, the e-th finite element, stress and strain may be calculated. Here, the structural equation may be expressed as two design variables, that is, ρₑ^{(PM)} and ρₑ^{(iron)} as shown in [Equation 4] to [Equation 6] below.

In detail, the structural equation is expressed as [Equation 4] below.

$$K u = F \qquad [ Equation 4 ]$$

Here, K denotes a stiffness matrix and also represents Eₑ^{(SIMP)} expressed as shown in [Equation 5] below, u denotes a displacement vector, and F denotes a force vector expressed as shown in [Equation 6] below.

The stiffness matrix is expressed as a function of two design variables, that is, ρₑ^{(PM)} and ρₑ^{(iron)} as shown in [Equation 5] below.

$${E}_{e}^{( SIMP )} = {E}_{min} + ( {E}^{( iron )} - {E}_{min} ) {( {ρ}_{e}^{( iron )} )}^{p} ( 1 - {( {ρ}_{e}^{( PM )} )}^{p} ) \qquad [ Equation 5 ]$$

$$\{ \begin{matrix}{E}_{e}^{( SIMP )} = {E}_{min} + ( {E}^{( iron )} - {E}_{min} ) {( {\underbrace{{ρ}_{e}^{( iron )}}}_{1} )}^{p} {( {\underbrace{1 - ( {\underbrace{{ρ}_{e}^{( iron )}}}_{0}}}_{1} )}^{p} ) \\ ( if {ρ}_{e}^{( iron )} = 1 and {ρ}_{e}^{( PM )} = 0 ) \\ \begin{matrix}{E}_{e}^{( SIMP )} = {E}_{min} + ( {E}^{( iron )} - {E}_{min} ) {( {\underbrace{{ρ}_{e}^{( iron )}}}_{1} )}^{p} \\ ( if {ρ}_{e}^{( iron )} = 1 and {ρ}_{e}^{( PM )} = 1 )\end{matrix} \\ \begin{matrix}{E}_{e}^{( SIMP )} = {E}_{min} + ( {E}^{( iron )} - {E}_{min} ) {( {\underbrace{1 - ( {\underbrace{{ρ}_{e}^{( iron )}}}_{0}}}_{1} )}^{p} ) \\ ( if {ρ}_{e}^{( iron )} = 0 and {ρ}_{e}^{( PM )} = 0 )\end{matrix} \\ \begin{matrix}{E}_{e}^{( SIMP )} = {E}_{min} + ( {E}^{( iron )} - {E}_{min} ) \\ ( if {ρ}_{e}^{( iron )} = 0 and {ρ}_{e}^{( PM )} = 1 )\end{matrix}\end{matrix}$$

Here, Eₑ^{(SIMP)} denotes Young's modulus of the e-th finite element, E^{(iron)} denotes Young's modulus of iron, and Eₘᵢₙ denotes a minimum value of Young's modulus.

The force vector is expressed as a function of two design variables, that is, ρₑ^{(PM)} and ρₑ^{(iron)} as shown in [Equation 6] below and represents a load.

$$[ \begin{matrix}{F}_{e , radial}^{( iron )} + {F}_{e , radial}^{( PM )} \\ {F}_{e , circumferential}^{( iron )} + {F}_{e , circumferential}^{( PM )}\end{matrix} ] = [ \begin{matrix}( {ρ}_{e}^{( iron )} {m}_{e}^{( iron )} + {ρ}_{e}^{( PM )} {m}_{e}^{( PM )} ) {r}_{e} {ω}_{max}^{2} \\ ( {ρ}_{e}^{( iron )} {m}_{e}^{( iron )} + {ρ}_{e}^{( PM )} {m}_{e}^{( PM )} ) {r}_{e} α\end{matrix} ] \qquad [ Equation 6 ]$$

Here, Fₑ^{(iron)} denotes a load generated due to iron in the e-th finite element, Fₑ^{(PM)} denotes a load generated due to the permanent magnet 127 in the e-th finite element, mₑ^{(iron)} denotes the weight of iron of the e-th finite element, mₑ^{(PM)} denotes the weight of the permanent magnet 127 of the e-th finite element, re denotes a distance between the origin and the e-th finite element, @ denotes the angular velocity of the rotor 120, and a denotes the angular acceleration of the rotor 120.

Finally, the structural property of multi-materials is expressed according to combination of design variables as shown in [Table 2] below.

TABLE 2

| | |
|---|---|
| Design variables | Structural property |

| ρₑ^{(iron)} | ρₑ^{(PM)} | θₑ^{(PM)} | Eₑ^{(SIMP)} | Fₑ |
|---|---|---|---|---|
| 0 | 0 | Not used | Eₘᵢₙ | [0, 0]^{T} |
| 1 | 1 | Not used | Eₘᵢₙ | Fₑ^{(iron)} + Fₑ^{(PM)} |
| 1 | 0 | Not used | E^{(iron)} | Fₑ^{(iron)} |
| 0 | 1 | Not used | E^{(PM)} = Eₘᵢₙ | Fₑ^{(PM)} |

As described above, through the procedure of FIG. 4, the computer device 200 may express at least four electromagnetic properties, for example, the relative density of the permanent magnet 127, the direction of the permanent magnet 127, the relative density of iron, and the relative density of air, and at least three structural properties, for example, the relative density of the permanent magnet 127, the relative density of iron, and the relative density of air, using combinations of three design variables, that is, ρₑ^{(PM)}, θₑ^{(PM)}, and ρₑ^{(iron)}.

Referring again to FIG. 3, in operations 320 and 330, the computer device 200 calculates an optimal current condition. When performing topology optimization, the topology of the rotor 120 changes to a structure for minimizing or maximizing an objective function while satisfying constraints according to the optimization sequence. Here, since the computer device 200 re-calculates an optimal current control condition according to a structural change of the rotor 120 from results of the multi-physics finite element analysis of the rotor 120, it is possible to adaptively apply current to the stator 110. In comparison, random fixed current is applied to the stator in the art.

In operation 320, the computer device 200 derives motor parameters of the electric motor 100 as functions of design variables through the electromagnetic finite element analysis. The present disclosure may acquire a plurality of motor parameters by parametrizing the electric motor 100 to calculate the optimal current control condition according to the topological change of the electric motor 100. The motor parameters include the strength (Φ_{PM}) of the permanent magnet 127 and a difference (L_{qd}=L_{q}−L_{d}) between q-axis inductance and d-axis inductance representing a saliency ratio of the iron core 121 in a d-q-axis rotational coordinate system. The inductance represents physical quantity indicating an amount of current generated when current flows.

Since the maximum torque of the electric motor 100 occurs at the maximum current, a relationship between d-axis current (i_{d}) and q-axis current (i_{q}) in the rotational coordinate system may be expressed as [Equation 7] below. If motor parameters (Φ_{PM}, L_{qd}=L_{q}−L_{d}) are known, the torque may be expressed as [Equation 8] below.

$${i}_{d}^{2} + {i}_{q}^{2} = {I}_{s}^{2} \leq {I}_{smax}^{2} \qquad [ Equation 7 ]$$

$${T}_{avg} = ( 3 / 4 ) {P}_{r} ( {Φ}_{PM} {i}_{q} + ( {L}_{d} - {L}_{q} ) {i}_{q} {i}_{d} ) \qquad [ Equation 8 ]$$

The core of the present disclosure is that the motor parameters (Φ_{PM}, L_{qd}=L_{q}−L_{d}) may be expressed as a function of a design variable set (ρ=[ρ₁, ρ₂, . . . , ρₑₘₐₓ]^{T}). Using SIMP equation, the average torque is the function of the design variable set (ρ), and Φ_{PM} and L_{qd}==L_{q}−L_{d} may be expressed as functions Φ_{PM}(ρ) and L_{qd}(ρ) of the design variable set. That is, as shown in [Equation 9] and [Equation 10] below, motor parameters Φ_{PM}(p) and L_{qd}(p) may be easily calculated from the design variable set (ρ).

$${Φ}_{PM} ( ρ ) = \frac{4}{3} \frac{1}{{I}_{smax} cos ( {β}^{*} )} \frac{{T}_{avg} ( ρ , {i}_{d}^{*} , {i}_{q} )}{{P}_{r}} \qquad [ Equation 9 ]$$

$${L}_{qd} ( ρ ) = {L}_{q} ( ρ ) - {L}_{d} ( ρ ) = \frac{4}{3} \frac{1}{{P}_{r}} \frac{( {T}_{avg} ( ρ , {i}_{d} , {i}_{q} ) - {T}_{avg} ( ρ , {i}_{d}^{*} , {i}_{q} ) )}{- {i}_{q} ( {i}_{d} - {i}_{d}^{*} )} \qquad [ Equation 10 ]$$

In operation 330, the computer device 200 derives the optimal current control condition based on the motor parameters. The computer device 200 derives the optimal current control condition for the stator 110 by considering the structure of the rotor 120. In detail, the computer device 200 derives the optimal current control condition by substituting the calculated motor parameter into a “maximum torque per ampere (MTPA)” algorithm or a field weakening or flux weakening (FW) algorithm. Through this, when performing topology optimization, the optimal current control condition may be adaptively updated in response to the changing topology.

In an example embodiment, the FW algorithm may calculate the optimal current control condition capable of producing the maximum torque per ampere while satisfying a voltage limit to operate the electric motor 100 within the voltage limit.

In another example embodiment, when substituting the motor parameters of [Equation 9] and [Equation 10] into the MTPA algorithm, an MTPA current phase angle (β^{MTPA}(ρ)) may be expressed as a function of the design variable set (ρ) as shown in [Equation 11] below. That is, an MTPA current condition or current phase angle may be easily calculated from the design variable set (ρ).

$${β}^{( MTPA )} ( ρ ) = {sin}^{- 1} ( \frac{- {Φ}_{PM} ( ρ ) + \sqrt{{Φ}_{PM}^{2} ( ρ ) + 8 {I}_{smax}^{2} {L}_{qd}^{2} ( ρ )}}{4 {I}_{smax} {L}_{qd} ( ρ )} ) \qquad [ Equation 11 ]$$

Finally, by substituting the MTPA current phase angle (β^{MTPA}(ρ)) of [Equation 11] into a torque equation as shown in [Equation 8] above, it is possible to calculate the average torque that considers the change in the design variable set (ρ) and the MTPA current control together as shown in [Equation 12] below. That is, the MTPA torque may be easily calculated from the design variable set (ρ).

$${T}_{avg}^{( MTPA )} ( ρ ) = {T}_{avg}^{( MTPA )} ( ρ , {\overline{i}}_{d}^{( MTPA )} ( ρ ) , {\overline{i}}_{q}^{( MTPA )} ( ρ ) ) = \frac{3}{4} {P}_{r} ( {Φ}_{PM} ( ρ ) {I}_{smax} cos {\overline{β}}^{( MTPA )} ( ρ ) + \frac{1}{2} {L}_{qd} ( ρ ) {I}_{smax}^{2} sin {\overline{β}}^{( MTPA )} ( ρ ) ) \qquad [ Equation 13 ]$$

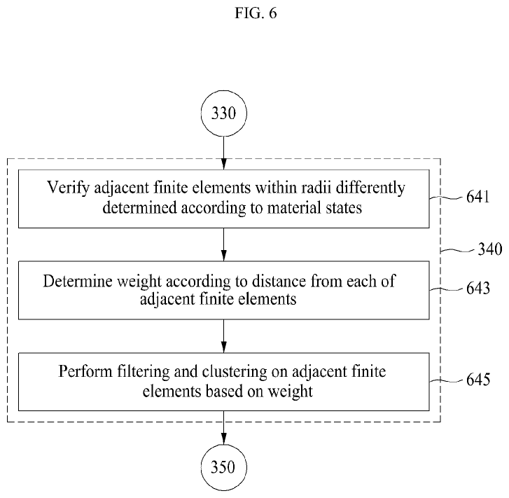

In operation 340, the computer device 200 derives topology optimization for the structure of the permanent magnet 127 in the rotor 120 using the design variables to maximize the torque density while minimizing the usage of the permanent magnet 127 for the electric motor 100. Here, the structure of the permanent magnet 127 includes quantity, dimension, and arrangement for the permanent magnet 127 in the rotor 120. In detail, in operation 340, the computer device 200 derives topology optimization by performing filtering and clustering on the finite elements. Further description related thereto will be made with reference to FIGS. 6, 7, and 8.

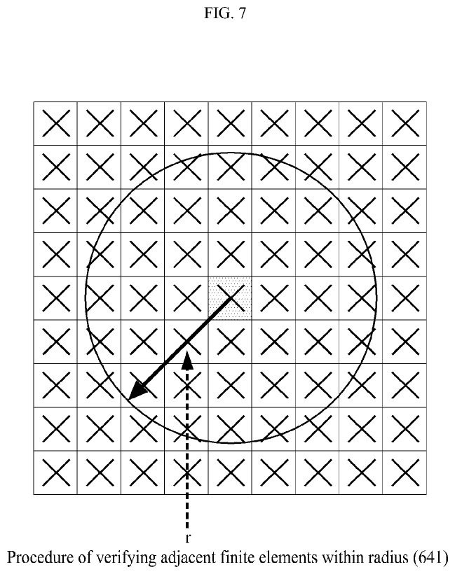

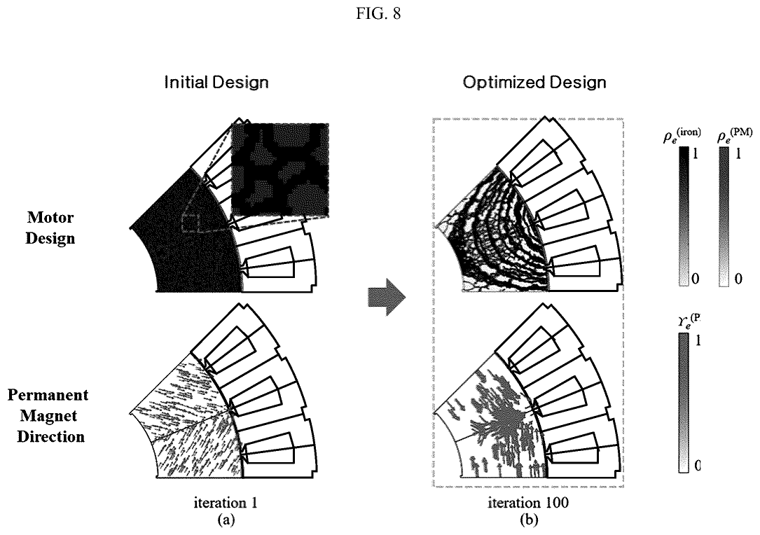

FIG. 6 is a flowchart illustrating in detail an operation (operation 340) of deriving topology optimization by performing filtering and clustering on finite elements in FIG. 3. FIG. 7 illustrates an example of an operation (operation 641) of verifying adjacent finite elements in FIG. 6. FIGS. 8, 9, and 10 illustrate examples of an operation (operation 645) of performing filtering and clustering on adjacent finite elements in FIG. 6.

Referring to FIG. 6, in operation 641, the computer device 200 verifies adjacent finite elements within radii (r) differently determined according to material states. In some example embodiments, the material states include the relative density of the permanent magnet 127, the direction of the permanent magnet 127, the relative density of iron in the rotor 120, and the relative density of air, and the different radii (r) are differently determined according to the four material states, respectively. For example, as shown in [Table 3] below, the different radii (r) may be determined for electromagnetic and structural properties of the permanent magnet 127 and iron, respectively. In detail, for each material state, the processor 240 verifies finite elements present within a corresponding radius (r) from an arbitrary finite element, for example, the e-th finite element as adjacent finite elements. For example, as shown in FIG. 7, the processor 240 may verify the adjacent finite elements based on the corresponding radius (r). This operation may also be referred to as individual filtering. Here, a set of adjacent finite elements within the radius (r) from the e-th finite element is expressed as [Equation 14] below.

TABLE 3

| | Electromagnetic | Structural |
|---|---|---|
| | property | property |
| Permanent magnet | 1 mm | 3 mm |
| Iron | 2 mm | 4 mm |

$${Π}_{e} = \{ {e}^{′} ‖ {r}_{{e}^{′}} - {r}_{e} ‖ \leq r \} \qquad [ Equation 14 ]$$

Here, re and re denote position vectors of the e-th finite element and an e′-th finite element, respectively.

In operation 643, the computer device 200 determines a weight according to a distance from each of the adjacent finite elements. Here, the weight represents a degree of effect of each of the adjacent finite elements for the e-th finite element. In more detail, a relative density of each of the adjacent finite elements represents the relative density of the e-th finite element, that is, the relative density of the permanent magnet 127, the relative density of iron in the rotor 120, and the relative density of air. In detail, the processor 240 determines a weight according a distance between the e-th finite element and each adjacent finite element as shown in [Equation 15] below.

$${w}_{{e}^{′}} = {( 1 - ‖ {r}_{{e}^{′}} - {r}_{e} ‖ / r )}^{q} ( {e}^{′} ∈ {Π}_{e} ) \qquad [ Equation 15 ]$$

Here, w_{θ′} denotes a weight representing the degree of effect of the e′-th finite element for the e-th finite element.

In operation 645, the computer device 200 performs filtering and clustering on the adjacent finite elements based on the weight. The processor 240 performs filtering and clustering for the adjacent finite elements based on the e-th finite element, based on the weight. In more detail, the processor 240 performs filtering and clustering on relative densities of the adjacent finite elements based on the relative density of the e-th finite element, based on the weight. The following [Equation 16] represents the relative density on which filtering and clustering is performed.

$${\hat{ρ}}_{e} = \frac{{\sum }_{{e}^{′} ∈ {Π}_{e}} {w}_{{e}^{′}} {ρ}_{{e}^{′}}}{{\sum }_{{e}^{′} ∈ {Π}_{e}} {w}_{{e}^{′}}} \qquad [ Equation 16 ]$$

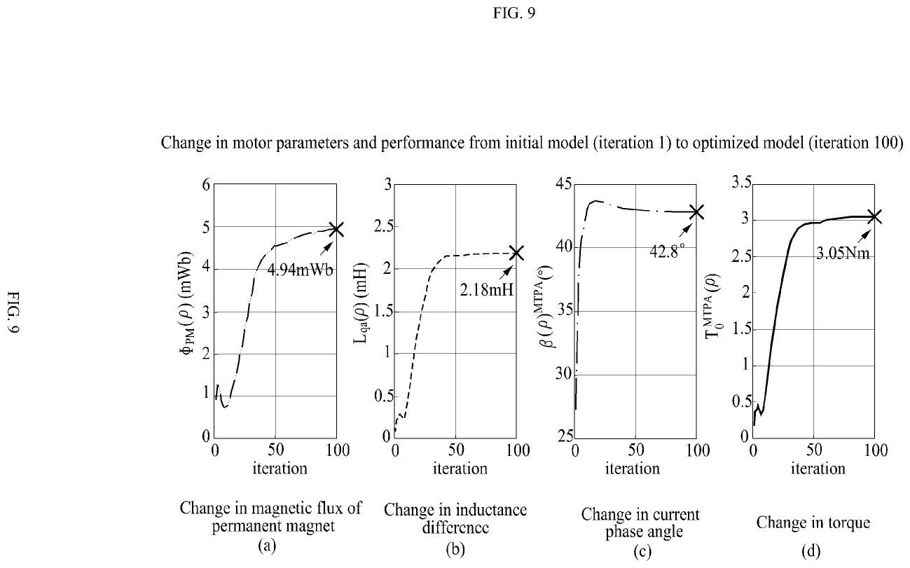

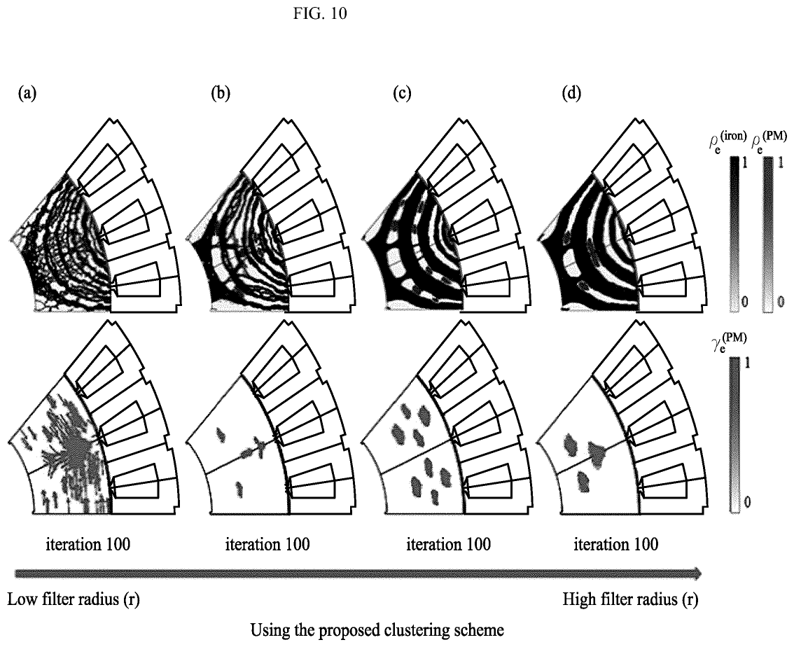

For example, as shown in FIGS. 8 and 10, filtering and clustering results for the permanent magnet 127 and iron may be acquired. In detail, a standard distribution as shown in (a) of FIG. 8 may represent a result distribution as shown in (b) of FIG. 8 through filtering and clustering. Here, as the radius (r) is set very small, the filtering and clustering results for the permanent magnet 127 and iron may be acquired as shown in (b) of FIG. 8. As filtering and clustering is iterated (e.g., 100 iterations), the magnetic flux of the permanent magnet 127 ((a) of FIG. 9), a difference between q-axis inductance and d-axis inductance ((b) of FIG. 9), a current phase angle ((c) of FIG. 9), and net torque may be converged to specific values, respectively. A standard distribution as shown in (a) of FIG. 10 may represent a result distribution as shown in one of (b), (c), and (d) of FIG. 10 through filtering and clustering. Here, the standard distribution as shown in (a) of FIG. 10 is the same as the standard distribution shown in FIG. 8. Here, (b) of FIG. 10 may represent a case in which the radius (r) is relatively small, that is, a case in which a weight for an adjacent finite element is relatively small, (d) of FIG. 10 may represent a case in which the radius (r) is relatively large, that is, a case in which the weight for the adjacent finite element is relatively large, and (c) of FIG. 10 may represent a case in which the radius (r) is medium, that is, a case in which the weight for the adjacent finite element is medium. This shows that, as the radius (r) increases, the performance of the rotor 120 may weaken, but the ease of manufacturing the rotor 120 may be improved. Through this, the structure of the permanent magnet 127 in the rotor 120, that is, topology optimization for quantity, dimension, and arrangement for the permanent magnet 127 in the rotor 120 is derived.

In addition, the processor 240 may set the torque density and the usage of the permanent magnet 127 as the objective function and constraints of design variables, respectively, and then may derive the topology optimization that minimizes or maximizes the objective function while satisfying the constraints. Here, the objective function or the constraints is set to at least one of the average torque, torque ripple, structural compliance, and the usage of the permanent magnet 127. For example, an optimization problem as shown in [Equation 17] below may be set. In [Equation 17] below, the objective function refers to average torque maximization and torque ripple minimization and the constraints refers to the structural compliance and the permanent magnet usage.

$$Find \qquad [ Equation 17 ]$$

$${ρ}_{total} = {[ {ρ}_{1}^{( iron )} , … , {ρ}_{emax}^{( iron )} , {ρ}_{1}^{( PM )} , … , {ρ}_{emax}^{( PM )} , {θ}_{1} , … , {θ}_{emax}^{( PM )} ]}^{T}$$

$$to minimize f ( {ρ}_{total} ) = - \frac{{T}_{avg}^{( MTPA )} ( {ρ}_{total} )}{{T}_{0}^{*}} + \frac{{T}_{ripple} ( {ρ}_{total} )}{{T}_{1}^{*}}$$

$$subject to {g}_{1} ( {ρ}_{total} ) = \frac{1}{{g}_{1}^{*}} ( C ( {ρ}_{total} ) - {C}^{( target )} ) \leq 0$$

$${g}_{2} ( {ρ}_{total} ) = \frac{1}{{g}_{2}^{*}} ( {Λ}^{( PM )} ( {ρ}_{total} ) - {Λ}^{( PM , target )} ) \leq 0$$

$${ρ}^{min} \leq {ρ}_{e}^{( iron )} \leq {ρ}^{max} , for e = 1 , … , {e}_{max}$$

$${ρ}^{min} \leq {ρ}_{e}^{( PM )} \leq {ρ}^{max} , for e = 1 , … , {e}_{max}$$

$$0 \leq {θ}_{e}^{( PM )} \leq 2 π , for e = 1 , … , {e}_{max}$$

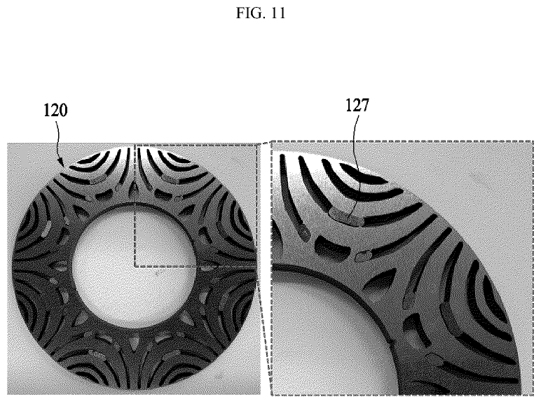

Referring again to FIG. 3, in operation 350, the computer device 200 determines the safety of the topology optimization through the structural finite element analysis. In operation 360, the computer device 200 may determine whether the safety converges to a preset reference value. Here, when it is determined that the safety does not converge to the reference value in operation 360, the computer device 200 repeats operations 310 to 360 by returning to operation 310. Here, the computer device 200 updates the design variables and then returns to operation 310. Meanwhile, when it is determined that the safety converges to the reference value in operation 360, the computer device 200 determines the corresponding topology optimization as resulting topology optimization. FIG. 11 illustrates an example of the rotor 120 manufactured with topology optimization for the structure of the permanent magnet 127 according to the present disclosure.

Since a structure of a permanent magnet is predefined relying on the intuition of a designer in the art, it is difficult to design an electric motor with nonlinearity (magnetic flux saturation and leakage flux) and complex structure. However, the present disclosure may perform a multi-material topology optimization of determining a permanent magnet structure, that is, quantity, dimension, and arrangement for a permanent magnet, for maximizing a torque density while minimizing permanent magnet usage for an electric motor based on a softwarely designed algorithm without prior information. According to the present disclosure, it is easy to design a complex electric motor with multiple constraints without a need to rely on the intuition of a designer. Accordingly, the present disclosure may significantly reduce an amount of time and cost used for design, manufacturing, and experiments by making it unnecessary to manufacture a plurality of individual products and repeat experiments for each individual product.

The present disclosure proposes a method and device for multi-material topology optimization for optimal arrangement of the permanent magnet 127 in the electric motor 100.

The present disclosure provides a method of the computer device 200 that performs multi-material topology optimization for optimal arrangement of the permanent magnet 127 in the electric motor 100 including the stator 110, the rotor 120, and at least one permanent magnet 127 provided to the rotor 120.

According to various example embodiments, the method may include expressing multi-materials of each of a plurality of finite elements divided from at least a partial area of the rotor 120, as a plurality of design variables defined to express multi-material states (operation 310) and deriving topology optimization for a structure of the permanent magnet 127 in the rotor 120 using the design variables, for at least one of usage minimization of the permanent magnet 127 and torque density maximization for the electric motor 100 (operation 320).

According to various example embodiments, the structure may include quantity, dimension, and arrangement for the permanent magnet 127 in the rotor 120.

According to various example embodiments, the material states may include a relative density of the permanent magnet 127, a direction of the permanent magnet 127, a relative density of iron in the rotor 120, and a relative density of air.

According to various example embodiments, when the number of material states is N, the number of design variables may be at least (N−1).

According to various example embodiments, the deriving of the topology optimization may include deriving the topology optimization by performing filtering and clustering on adjacent finite elements within radii differently determined according to the material states (operation 340).

According to various example embodiments, the deriving of the topology optimization may include setting the torque density and the usage of the permanent magnet 127 as an objective function and constraints of the design variables, respectively, and deriving the topology optimization that minimizes or maximizes the objective function while satisfying the constraints.

According to various example embodiments, the deriving of the topology optimization may include calculating an optimal current control condition for the stator 110 and deriving the topology optimization by applying the optimal current control condition.

According to various example embodiments, the calculating of the optimal current control condition may include deriving motor parameters of the electric motor 100 as functions of the design variables through electromagnetic finite element analysis (operation 320) and deriving the optimal current control condition by substituting the motor parameters into an optimal current calculation algorithm (operation 330).

According to various example embodiments, the motor parameters may represent a magnetic flux of the permanent magnet 127 and a difference between inductances of two axes that define a rotational coordinate system on the rotational coordinate system in which the rotor 120 rotates, and the optimal current calculation algorithm may include at least one of a maximum torque per ampere (MPTA) algorithm and a field weakening or flux weakening (FW) algorithm.

According to various example embodiments, the method may further include determining safety of the topology optimization through structural finite element analysis (operation 350).

The present disclosure provides the computer device 200 that performs multi-material topology optimization for optimal arrangement of the permanent magnet 127 in the electric motor 100 including the stator 110, the rotor 120, and at least one permanent magnet 127 provided to the rotor 120.

According to various example embodiments, the computer device 200 includes the memory 230 and the processor 240 configured to connect to the memory 230 and to execute at least one instruction stored in the memory 230. The processor 240 may be configured to express multi-materials of each of a plurality of finite elements divided from at least a partial area of the rotor 120, as a plurality of design variables defined to express multi-material states, and to derive topology optimization for a structure of the permanent magnet 127 in the rotor 120 using the design variables, for at least one of usage minimization of the permanent magnet 127 and torque density maximization for the electric motor 100.

According to various example embodiments, the structure may include quantity, dimension, and arrangement for the permanent magnet 127 in the rotor 120.

According to various example embodiments, the material states may include a relative density of the permanent magnet 127, a direction of the permanent magnet 127, a relative density of iron in the rotor 120, and a relative density of air.

According to various example embodiments, when the number of material states is N, the number of design variables may be at least (N−1).

According to various example embodiments, the processor 240 may be configured to derive the topology optimization by performing filtering and clustering on adjacent finite elements within radii differently determined according to the material states.

According to various example embodiments, the processor 240 may be configured to set the torque density and the usage of the permanent magnet 127 as an objective function and constraints of the design variables, respectively, and to derive the topology optimization that minimizes or maximizes the objective function while satisfying the constraints.

According to various example embodiments, the processor 240 may be configured to calculate an optimal current control condition for the stator 110 and to derive the topology optimization by applying the optimal current control condition.

According to various example embodiments, the processor 240 may be configured to derive motor parameters of the electric motor 100 as functions of the design variables through electromagnetic finite element analysis and to derive the optimal current control condition by substituting the motor parameters into an optimal current calculation algorithm.

According to various example embodiments, the motor parameters may represent a magnetic flux of the permanent magnet 127 and a difference between inductances of two axes that define a rotational coordinate system on the rotational coordinate system in which the rotor 120 rotates, and the optimal current calculation algorithm may include at least one of a maximum torque per ampere (MPTA) algorithm and a field weakening or flux weakening (FW) algorithm.

According to various example embodiments, the processor 240 may be configured to determine safety of the topology optimization through structural finite element analysis.

The methods according to example embodiments may be provided in a computer program stored in non-transitory computer-readable media to be executed on a computer. Here, the media may be to continuously store a computer-executable program or to temporarily store the same for execution or download. Also, the media may be various types of recording methods or storage methods in which single hardware or a plurality of hardware is combined and may be distributed over a network without being limited to a medium that is directly connected to a computer system. Examples of the media include magnetic media such as hard disks, floppy disks, and magnetic tapes; optical media such as CD ROM and DVD; magneto-optical media such as floptical disks; and hardware devices that are specially configured to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

The methods, operations, or techniques of the present disclosure may be implemented by various manners. For example, the techniques may be implemented by hardware, firmware, software, or combinations thereof. Those skilled in the art may understand that various logical blocks, modules, circuitries, and algorithm operations described in association with the disclosure herein may be implemented using electronic hardware, computer software, or combinations thereof. To clearly describe this interchange between hardware and software, various components, blocks, modules, circuitries, and operations are described above in terms of functions thereof. Whether such functions are implemented as hardware or implemented as software depends on design applications imposed to the overall system and a particular application. Those skilled in the art may implement the aforementioned functions in various manners for each specific application, but such implementations should not be interpreted as deviating from the scope of the present disclosure.

In hardware implementation, processing units used to perform the techniques may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, electronic devices, other electronic units designed to perform the functions described herein, computer, or combinations thereof.

Therefore, various logic blocks, modules, and circuitries described in association with the present disclosure may be implemented or performed in any combination with a general-purpose processor, a DSP, an ASIC, an FPGA, or other programmable logic devices, a discrete gate or transistor logic, discrete hardware components, or devices designed to perform functions described herein. The general-purpose processor may be a microprocessor and, alternatively, the processor may be a conventional processor, a controller, a microcontroller, or a state machine. The processor may be implemented using a combination of computing devices, for example, a DSP and a microprocessor, a plurality of microprocessors, and one or more microprocessors associated with a DSP core, or a combination of other components.

In firmware and/or software implementation, the techniques may be implemented as instructions stored in non-transitory computer-readable recording media, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), and a magnetic or optical data storage device. The instructions may be executable by one or more processors and may cause the processor(s) to perform specific aspects of the functions described herein.

Although the example embodiments are described as using aspects of the currently disclosed subject matter in one or more stand-alone computer systems, the present disclosure is not limited thereto and may be implemented in conjunction with an arbitrary computing environment, such as network or distributed computing environment. Also, aspects of the subject matter in the present disclosure may be implemented in a plurality of processing chips or devices, and storage may be similarly affected across the plurality of devices. The devices may include PCs, network servers, and portable devices.

Although the present disclosure is described with respect to some example embodiments, various modifications and changes may be made without departing from the scope of the present disclosure that may understood by those skilled in the art. Also, such modifications and changes should be understood to fall within the scope of the claims.

What is claimed is:

1. A method of a computer device that performs multi-material topology optimization for optimal arrangement of a permanent magnet in an electric motor comprising a stator, a rotor, and at least one permanent magnet provided to the rotor, the method comprising:
expressing multi-materials of each of a plurality of finite elements divided from at least a partial area of the rotor, as a plurality of design variables defined to express multi-material states; and
deriving topology optimization for a structure of the permanent magnet in the rotor using the design variables, for at least one of usage minimization of the permanent magnet and torque density maximization for the electric motor.

2. The method of claim 1, wherein the structure includes quantity, dimension, and arrangement for the permanent magnet in the rotor.

3. The method of claim 1, wherein the material states include a relative density of the permanent magnet, a direction of the permanent magnet, a relative density of iron in the rotor, and a relative density of air.

4. The method of claim 1, wherein, when the number of material states is N, the number of design variables is at least (N−1).

5. The method of claim 1, wherein the deriving of the topology optimization comprises deriving the topology optimization by performing filtering and clustering on adjacent finite elements within radii differently determined according to the material states.

6. The method of claim 1, wherein the deriving of the topology optimization comprises:
setting the torque density and the usage of the permanent magnet as an objective function and constraints of the design variables, respectively; and
deriving the topology optimization that minimizes or maximizes the objective function while satisfying the constraints.

7. The method of claim 1, wherein the deriving of the topology optimization comprises:
calculating an optimal current control condition for the stator; and
deriving the topology optimization by applying the optimal current control condition.

8. The method of claim 7, wherein the calculating of the optimal current control condition comprises:
deriving motor parameters of the electric motor as functions of the design variables through electromagnetic finite element analysis; and
deriving the optimal current control condition by substituting the motor parameters into an optimal current calculation algorithm,
the motor parameters represent a magnetic flux of the permanent magnet and a difference between inductances of two axes that define a rotational coordinate system on the rotational coordinate system in which the rotor rotates, and
the optimal current calculation algorithm includes at least one of a maximum torque per ampere (MPTA) algorithm and a field weakening or flux weakening (FW) algorithm.

9. The method of claim 1, further comprising:
determining safety of the topology optimization through structural finite element analysis.

10. A computer device that performs multi-material topology optimization for optimal arrangement of a permanent magnet in an electric motor comprising a stator, a rotor, and at least one permanent magnet provided to the rotor, the computer device comprising:
a memory; and
a processor configured to connect to the memory, and to execute at least one instruction stored in the memory,
wherein the processor is configured to,
express multi-materials of each of a plurality of finite elements divided from at least a partial area of the rotor, as a plurality of design variables defined to express multi-material states, and
derive topology optimization for a structure of the permanent magnet in the rotor using the design variables, for at least one of usage minimization of the permanent magnet and torque density maximization for the electric motor.

11. The computer device of claim 10, wherein the structure includes quantity, dimension, and arrangement for the permanent magnet in the rotor.

12. The computer device of claim 10, wherein the material states include a relative density of the permanent magnet, a direction of the permanent magnet, a relative density of iron in the rotor, and a relative density of air.

13. The computer device of claim 10, wherein, when the number of material states is N, the number of design variables is at least (N−1).

14. The computer device of claim 10, wherein the processor is configured to derive the topology optimization by performing filtering and clustering on adjacent finite elements within radii differently determined according to the material states.

15. The computer device of claim 10, wherein the processor is configured to,
set the torque density and the usage of the permanent magnet as an objective function and constraints of the design variables, respectively, and
derive the topology optimization that minimizes or maximizes the objective function while satisfying the constraints.

16. The computer device of claim 10, wherein the processor is configured to,
calculate an optimal current control condition for the stator, and
derive the topology optimization by applying the optimal current control condition.

17. The computer device of claim 10, wherein the processor is configured to,
derive motor parameters of the electric motor as functions of the design variables through electromagnetic finite element analysis, and
derive the optimal current control condition by substituting the motor parameters into an optimal current calculation algorithm,
the motor parameters represent a magnetic flux of the permanent magnet and a difference between inductances of two axes that define a rotational coordinate system on the rotational coordinate system in which the rotor rotates, and
the optimal current calculation algorithm includes at least one of a maximum torque per ampere (MPTA) algorithm and a field weakening or flux weakening (FW) algorithm.

18. The computer device of claim 10, wherein the processor is configured to determine safety of the topology optimization through structural finite element analysis.

19. A non-transitory computer-readable recording medium storing instructions that, when executed by a processor, cause the processor to perform a method of performing multi-material topology optimization for optimal arrangement of a permanent magnet in an electric motor including a stator, a rotor, and at least one permanent magnet provided to the rotor, the method comprising:
expressing multi-materials of each of a plurality of finite elements divided from at least a partial area of the rotor, as a plurality of design variables defined to express multi-material states; and
deriving topology optimization for a structure of the permanent magnet in the rotor using the design variables, for at least one of usage minimization of the permanent magnet and torque density maximization for the electric motor.

20. The non-transitory computer-readable recording medium of claim 19, wherein the deriving of the topology optimization comprises deriving the topology optimization by performing filtering and clustering on adjacent finite elements within radii differently determined according to the material states.
